(19) United States
(12) Patent Application Publication
(10) Pub. No.: US 2008/0123155 A1
(43) Pub. Date: May 29, 2008

(54) Data communication system, image forming apparatus, data communication device, storage medium stored with a program and data communication method

(75) Inventors: Junichi Hase, Osaka-shi (JP); Kaitaku Ozawa, Itami-shi (JP); Ryuichi Kitaoka, Uji-shi (JP); Toshiya Shozaki, Osaka-shi (JP)

Correspondence Address: BUCHANAN, INGERSOLL & ROONEY PC, POST OFFICE BOX 1404, ALEXANDRIA, VA, 22313-1404, US

(73) Assignee: Konica Minolta Business Technologies, Inc., Tokyo (JP)

(21) Appl. No.: 11/979,455

(22) Filed: Nov. 2, 2007

(30) Foreign Application Priority Data
Nov. 29, 2006 (JP) 2006-322599

(51) Int. Cl. H04N 1/00

(52) U.S. Cl. 358/425

(57) ABSTRACT

An image forming apparatus executes a multicast transmission of image data to a computer and other devices. Concurrently, the image forming apparatus stores history information on the multicast transmission, and the history information includes destinations of the multicast transmission. The computer receives the image data from the image forming apparatus by the multicast transmission. Then, when the computer is to execute a reply multicast transmission in reply to the multicast transmission, the computer, by using a printing driver for the image forming apparatus, sends the data name of the image data and data to be sent by the reply multicast transmission to the image forming apparatus. The image forming apparatus receives the data name and the data to be sent by the reply multicast transmission, and the image forming apparatus designates other computers and/or devices as destinations of the reply multicast transmission, based on the history information and the data name. Then, the image forming apparatus executes the reply multicast transmission to the designated computers and devices.

This application is based on Japanese patent application No. 2006-322599 filed on Nov. 29, 2006, the content of which is herewith incorporated by reference.

### BACKGROUND OF THE INVENTION

1. Field of the Invention

The present invention relates to a data communication system, an image forming apparatus, a data communication device, a storage medium stored with a program and a data communication method, and more particularly to a data communication system, an image forming apparatus, a data communication device, a storage medium stored with a program and a data communication method for performing a multicast transmission and a reply multicast transmission.

2. Description of Related Art

U.S. Pat. No. 5,632,018 discloses a technical idea to perform a reply multicast transmission in reply to an e-mail sent by a multicast transmission. Further, US2002/0140989 A1 discloses a technical idea to perform a reply multicast transmission in reply to a multicast transmission previously executed to a plural number of destinations of different communication protocols, such as an e-mail, a facsimile, etc.

According to the prior arts, however, in order to perform a reply multicast transmission in reply to a previous multicast transmission, a user must carry out troublesome operations.

For example, when in reply to an e-mail sent by a multicast transmission, a user is to make alterations to data attached to the e-mail and is to send the altered data to the destinations of the multicast transmission, first, the user stores the data attached to the e-mail in a storage section. Next, the user alters the stored data with an application software, and the user stores the altered data in the storage section again. Then, an e-mail with the stored altered data attached thereto is sent by a reply multicast transmission.

If the destinations of the multicast transmission are of different communication protocols, the operations are more troublesome. For example, according to US 2002/0140989 A1, in such a case, a user makes an access to a URL shown in an e-mail or facsimile data to open a reply instruction area, in which the user manually inputs destinations for a reply multicast transmission. In the device from which the multicast transmission was sent, the data are transformed into formats in accordance with communication protocols of the respective destinations, and then, a reply multicast transmission is executed.

### SUMMARY OF THE INVENTION

An object of the present invention is to provide a data communication system, an image forming apparatus, a data communication device, a storage medium stored with a program and a data communication method wherein a reply multicast transmission in reply to a multicast transmission can be carried out easily.

The present invention relates to a data communication system wherein an image forming apparatus and a data communication device are connected to each other so as to be communicable with each other. In the data communication system according to the present invention, the image forming apparatus comprises: a first transmitting section for executing a multicast transmission of first data to a plural number of destinations; a storage section for storing history information on executed multicast transmissions, the history information including destinations of the multicast transmissions; and a printing section for printing an image in accordance with print data. The data communication device comprises: a second receiving section for receiving the first data sent by the multicast transmission; a data generating section for generating print data comprising identification information for identifying the multicast transmission and second data to be sent by a reply multicast transmission; and a second transmitting section for sending the print data to the image forming apparatus. The image forming apparatus further comprises: a first receiving section for receiving the print data; an analyzing section for analyzing the print data and extracting the identification information from the print data; and a designating section for designating destinations of the reply multicast transmission based on the history information and the identification information. In the data communication system, the first transmitting section executes the reply multicast transmission of the second data to the destinations designated by the designating section. In the present invention, the second data may be identical to the first data, may be data altered from the first data and may be completely different from the first data.

The present invention is applicable to a data communication method which is carried out by a data communication system wherein an image forming apparatus comprising a printing section for printing an image in accordance with print data and a data communication device are connected to each other so as to be communicable with each other. More specifically, the data communication method according to the present invention comprises: a step wherein the image forming apparatus executes a multicast transmission of first data to a plural number of destinations; a step wherein the image forming apparatus stores history information on the multicast transmission, the history information including destinations of the multicast transmission; a step wherein the data transmission device receives the first data sent by the multicast transmission; a step wherein the data transmission device generates print data comprising identification information for identifying the multicast transmission and second data to be sent by a reply multicast transmission; a step wherein the data communication device sends the print data to the image forming apparatus; a step wherein the image forming apparatus receives the print data; a step wherein the image forming apparatus analyzes the print data and extracts the identification information from the print data; a step wherein the image forming apparatus designates destinations of the reply multicast transmission based on the history information and the identification information; and a step wherein the image forming apparatus executes the reply multicast transmission of the second data to the designated destinations.

The present invention is also applicable to the image forming apparatus in the above-described data communication system. More specifically, the image forming apparatus according to the present invention comprises: a transmitting section for sending first data to a plural number of destinations by a multicast transmission; a storage section for storing history information on executed multicast transmissions, the history information including destinations of the multicast transmissions; a printing section for printing an image in accordance with print data; a receiving section for receiving print data from one of the destinations of the multicast transmission of the first data, said print data comprising identification information for identifying the multicast transmission and second data to be sent by a reply multicast transmission; an analyzing section for analyzing the print data and extracting the identification information from the print data; and a first designating section for designating destinations of the reply multicast transmission based on the history information and the identification information, and in the image forming apparatus, said transmitting section executes the reply multicast transmission of the second data to the destinations designated by the first designating section.

The present invention is also applicable to the data communication device in the above-described data communication system. More specifically, the data communication device according to the present invention comprises: a receiving section for receiving first data sent from an image forming apparatus by a multicast transmission; a generating section for generating print data comprising identification information for identifying the multicast transmission and second data to be sent by a reply multicast transmission; and a transmitting section for sending the print data to the image forming apparatus.

Further, the present invention is applicable to a storage medium stored with a program carried out by the data communication device which receives first data sent from an image forming apparatus by a multicast transmission. The program controls the data transmission device to carry out a procedure comprising: a step of generating print data comprising identification information for identifying a multicast transmission and second data to be sent by a reply multicast transmission; and a step of sending the print data to the image forming apparatus.

### BRIEF DESCRIPTION OF THE DRAWINGS

This and other objects and features of the present invention will be apparent from the following description with reference to the accompanying drawings, in which:

FIG. 1 is a block diagram showing an exemplary data communication system according to the present invention;

FIG. 2 is a block diagram showing an exemplary structure of an image forming apparatus;

FIG. 3 is a block diagram showing an exemplary structure of a computer;

FIG. 4 is a block diagram showing an exemplary structure of a printer;

FIG. 5 is a block diagram showing an exemplary structure of a facsimile;

FIGS. 6 and 7 are flowcharts showing a procedure according to a first embodiment carried out by the image forming apparatus for a multicast transmission;

FIG. 8 is an illustration of an exemplary selection screen for selecting transmission ways;

FIG. 9 is an illustration of an exemplary input screen which is displayed when an e-mail transmission is selected.

FIG. 10 is an illustration of an exemplary data name;

FIG. 11 is an illustration of an exemplary data table according to the first embodiment;

FIG. 12 is a flowchart carried out by the image forming apparatus at step S107 in the flowchart of FIG. 7 for transforming image data into a format suited as an attachment to an e-mail and for sending an e-mail with the attachment;

FIG. 13 is an exemplary e-mail sent by a multicast transmission;

FIG. 14 is a flowchart carried out by the image forming apparatus at step S109 in the flowchart of FIG. 7 for transforming image data into facsimile data and for sending the facsimile data;

FIG. 15 is an illustration of exemplary facsimile data to be sent by a multicast transmission;

FIG. 16 is a flowchart carried out by the image forming apparatus at step S111 in the flowchart of FIG. 7 for transforming image data into print data and for sending the print data;

FIG. 17 is a flowchart carried out by the image forming apparatus at step S113 in the flowchart of FIG. 7 for transforming image data into a format suited for file transfer, for executing the file transfer and for sending a notice e-mail;

FIG. 18 is an illustration of an exemplary notice e-mail to a user E during a procedure for a multicast transmission;

FIGS. 19 and 20 are flowcharts carried out by the computer for a reply multicast transmission;

FIG. 21 is an illustration of a properties screen for a printing driver installed in the computer;

FIG. 22 is a flowchart carried out by a CPU of the computer and by a CPU of the image forming apparatus at step S606 in the flowchart of FIG. 19;

FIG. 23 is an illustration showing a structure of transmission data;

FIGS. 24 and 25 are flowcharts carried out by the image forming apparatus after the image forming apparatus receives the transmission data;

FIG. 26 is a flowchart showing a procedure according to a second embodiment carried out by the image forming apparatus for a multicast transmission;

FIG. 27 is an illustration of a data table used in the second embodiment;

FIGS. 28 and 29 are flowcharts showing a procedure according to the second embodiment carried out by the computer for a reply multicast transmission;

FIG. 30a and 30b are illustrations of a properties screen for a reply multicast transmission displayed on a display of the computer; and

FIG. 31 is a flowchart carried out by the computer and by the image forming apparatus for a reply multicast transmission.

### DETAILED DESCRIPTION OF THE PREFERRED EMBODIMENTS

Embodiments of a data communication system, an image forming apparatus, a data communication device, a program and a data communication method according to the present invention are hereinafter described with reference to the accompanying drawings.

### Structure of Data Communication system

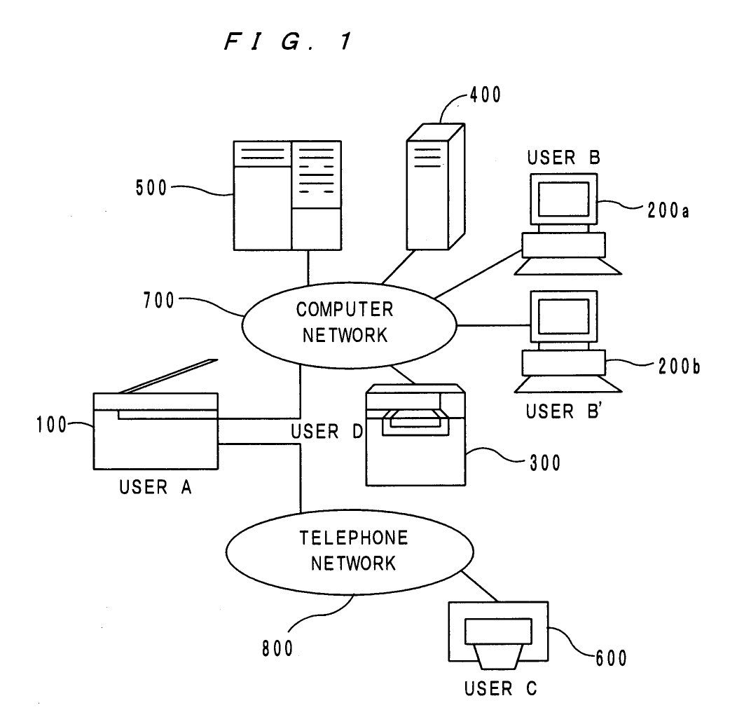

FIG. 1 is a block diagram showing a data communication system according to the present embodiment. The data communication system comprises an image forming apparatus 100, computers 200a and 200b functioning as data communication devices, a printer 300, an e-mail server 400, an FTP server 500 and a facsimile 600. In this embodiment, a user A uses the image forming apparatus 100, a user B uses the computer 200a, and a user B′ uses the computer 200b. A user C uses the facsimile 600, and a user D uses the printer 300. Further, a computer (not shown) used by a user E is connected to the FTP server 500 via a computer network 700.

The image forming apparatus 100 is connected to the computer network 700 and to a telephone line network 800. The computer network 700 is, for example, a LAN (local area network), a WAN (wide area network) or an internet. The telephone line network 800 is, for example, a public telephone network.

The image forming apparatus 100 is an MFP (multi-function peripheral) having a function as a scanner for obtaining image data by reading a document image, a function as a printer for printing an image in accordance with print data and a function as a facsimile for sending and receiving facsimile data. The image forming apparatus 100 further transforms the obtained image data into formats suited for various communication protocols.

More specifically, the image forming apparatus 100 transforms image data obtained by reading of a document image into an image file and sends an e-mail with the image file attached thereto via the computer network 700. The e-mail sent from the image forming apparatus 100 is stored in mail boxes in the e-mail server 400, and the computers 200a and 200b (clients) receive the e-mail from the respective mail boxes.

The image forming apparatus 100 is capable of sending the image data to the printer 300 as print data. The image forming apparatus 100 is also capable of sending the image file to the FTP server 500 by use of an FTP (file transfer protocol). Further, the image forming apparatus is capable of sending the image data to the facsimile 600 as facsimile data.

Moreover, the image forming apparatus 100 is capable of executing a multicast transmission of image data which were transformed into various data formats. In this embodiment, a multicast transmission means sending data, transformed if necessary from an original format, to a plural number of destinations substantially at a time.

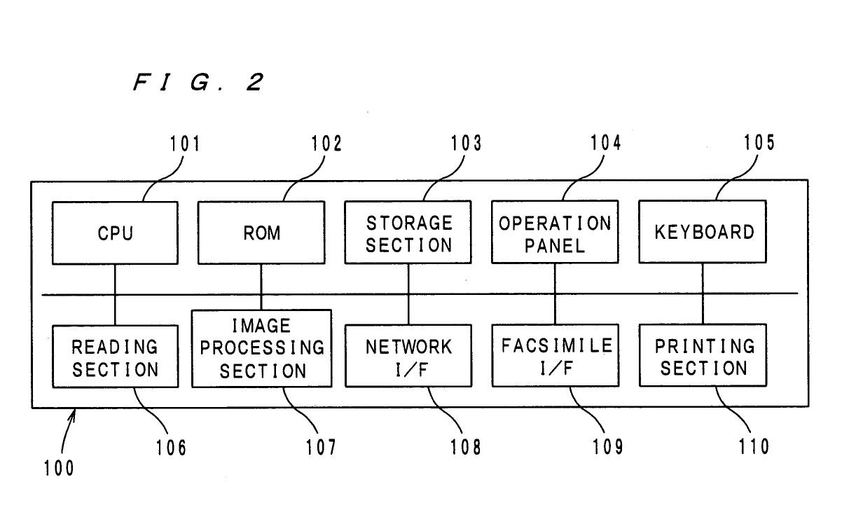

FIG. 2 is a block diagram showing an exemplary structure of the image forming apparatus 100. The image forming apparatus 100 comprises a CPU 101, a ROM 102, a storage section 103, an operation panel 104, a keyboard 105, a reading section 106, an image processing section 107, a network interface 108, a facsimile interface 109 and a printing section 110. These sections are connected to each other via buses.

The CPU 101 performs controls and operations. The ROM 102 stores programs therein. The storage section 103 comprises a RAM, for example, functioning as a working area to be temporarily stored with data and a hard disk to be stored with programs and data. The operation panel 104 receives various inputs and makes various displays. The operation panel 104 has a touch panel and other mechanical keys. The keyboard 105 is used for inputs of characters and codes.

The reading section 106 is a scanner engine which obtains image data by reading a document image. The image processing section 107 performs various kinds of image processing. Specifically, the image processing includes, for example, a process of transforming image data obtained by the reading section 106 and data to be sent to other devices into various communication protocols.

The network interface 108 is for communication via a computer network 700. Specifically, the network interface 108 is an interface for communication with the computers 200a and 200b, the printer 300, the e-mail server 400 and the FTP server 500. In the meantime, the facsimile interface 109 is for communication via the telephone line network 800, and more specifically, is an interface for communication with the facsimile 600. The printing section 110 prints an image on a recording sheet of, for example, paper in accordance with print data sent from the computers 200a, 200b, etc.

Next, the computers 200a and 200b, the e-mail server 400 and the FTP server 500 are described. The computers 200a and 200b are of the same structure, and here, the computer 200a is described.

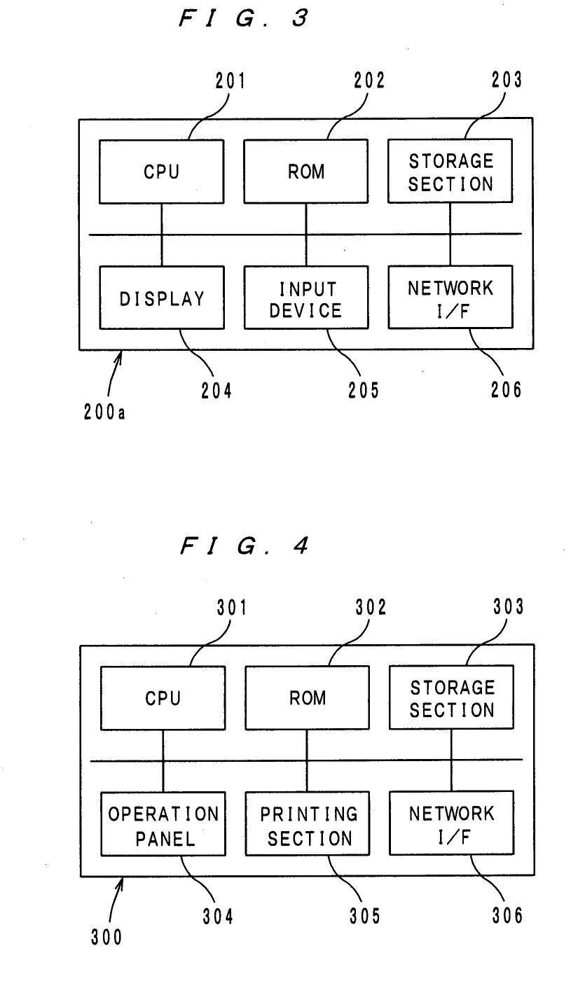

FIG. 3 is a block diagram showing an exemplary structure of the computer 200a. The computer 200a comprises a CPU 201, a ROM 202, a storage section 203, a display 204, an input device 205 and a network interface 206. The CPU 201 performs controls and operations. The ROM 202 stores programs therein. The storage section 203 comprises a RAM, for example, functioning as a working area to be temporarily stored with data and a hard disk to be stored with programs and data. In the hard disk, an e-mail software is installed so that formation and edition of e-mails, mail sending/receiving, reply mail sending, storage and management of received e-mails can be executed. Also, a browser which permits communication with other devices by use of HTTP (hypertext Transfer Protocol) may be installed. The display 204 displays various kinds of information.

The input device 205 is a pointing device such as a keyboard, a mouse, etc. The network interface 206 is for communication via the computer network 700.

The computer 200a is capable of making alterations (for example, corrections/revisions) to data which were sent from the image forming apparatus 100 by a multicast transmission and then of executing a reply multicast transmission of the altered data to the computer 200b, the printer 300, the FTP server 500 and the facsimile 600, which were the other destinations of the multicast transmission from the image forming apparatus 100. In this embodiment, a reply multicast transmission means sending data from one of the destinations of a previous multicast transmission to the other destinations substantially at a time.

The computers 200a, 200b, the e-mail server 400 and the FTP server 500 are substantially of the same structure except that the programs installed in the respective devices are different from each other. Specifically, the e-mail server 400 is installed with a software for executing e-mail transmissions and management of e-mails in mail boxes. The FTP server 500 is installed with a software for executing file transfers by use of a file transfer protocol.

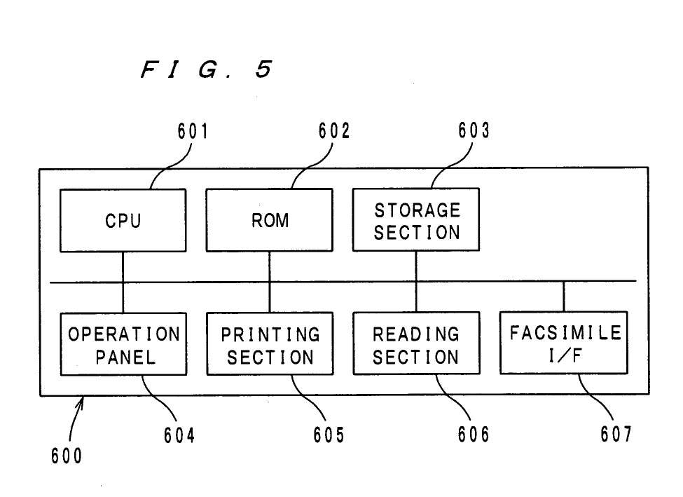

FIG. 4 is a block diagram showing an exemplary structure of the printer 300. The printer 300 comprises a CPU 301, a ROM 302, a storage section 303, an operation panel 304, a printing section 305 and a network interface 306.

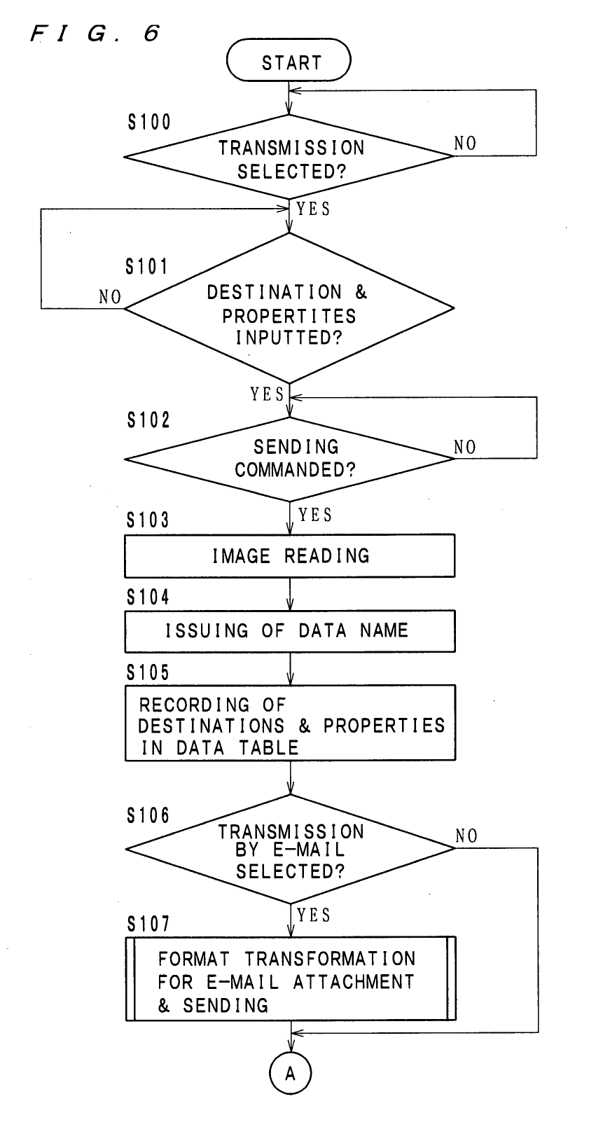

FIG. 5 is a block diagram showing an exemplary structure of the facsimile 600. The facsimile 600 comprises a CPU 601, a ROM 602, a storage section 603, an operation panel 604, a printing section 605, a reading section 606 and a facsimile interface 607.

### First Embodiment

### [Operation of Data Communication System]

Operation of the data communication system of the structure described above is hereinafter described with reference to the accompanying drawings. The data communication system performs two procedures, namely, a procedure wherein the image forming apparatus 100 executes a multicast transmission of data and a procedure wherein the computer 200a makes alterations to the data sent from the image forming apparatus 100 by the multicast transmission and sends the altered data to a plural number of destinations (the computer 200b, the printer 300, the FTP server 500 and the facsimile 600) by a reply multicast transmission. In the data communication system, in order to carry out a reply multicast transmission, the computer 200a uses a printing driver for making a print command to the image forming apparatus 100, and therefore, the procedure for executing a reply multicast transmission is simple.

### [Multicast Transmission]

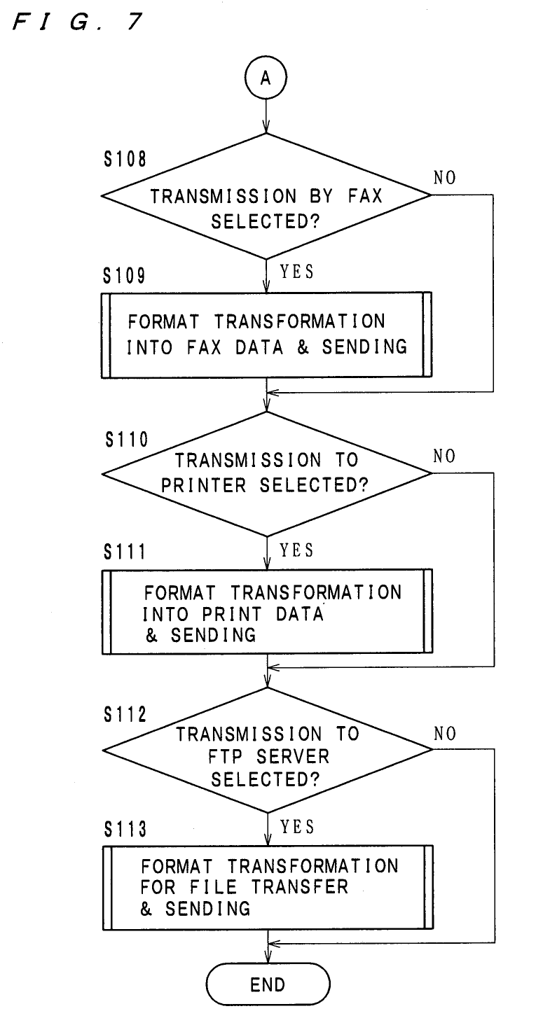

FIGS. 6 and 7 are flowcharts showing the procedure for a multicast transmission carried out by the image forming apparatus 100. The algorithm shown by the flowcharts in FIGS. 6 and 7 is stored in the ROM 102 or in the storage section 103 as a control program, and the algorithm is carried out by the CPU 101.

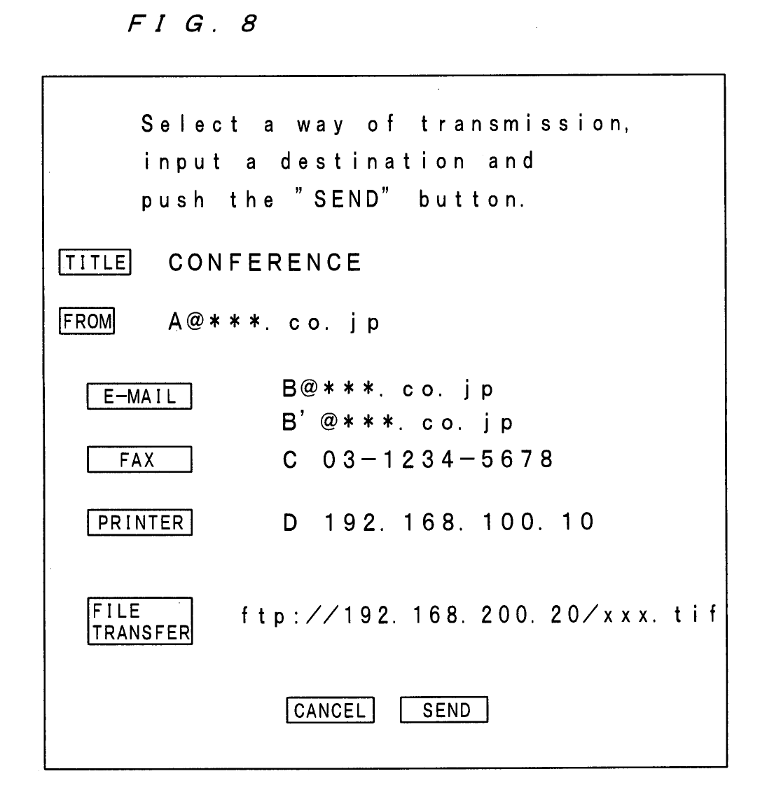

The CPU 101 stands by at step S100 while detecting whether the user A has selected either of the ways of data transmission shown in a transmission selection screen displayed on the operation panel 104. FIG. 8 shows an example of the transmission selection screen. The CPU 101 detects whether either of the buttons provided for the respective ways of data transmission has been pushed. More specifically, four kinds of transmission ways (four kinds of communication protocols), namely, transmission by e-mail, transmission by facsimile, transmission to a printer and file transfer are listed. The user A selects a desired one from these four transmission ways. When the user A has selected one from the transmission ways, the processing goes to step S101. The processing stands by at step S100 until the user A selects one from the transmission ways.

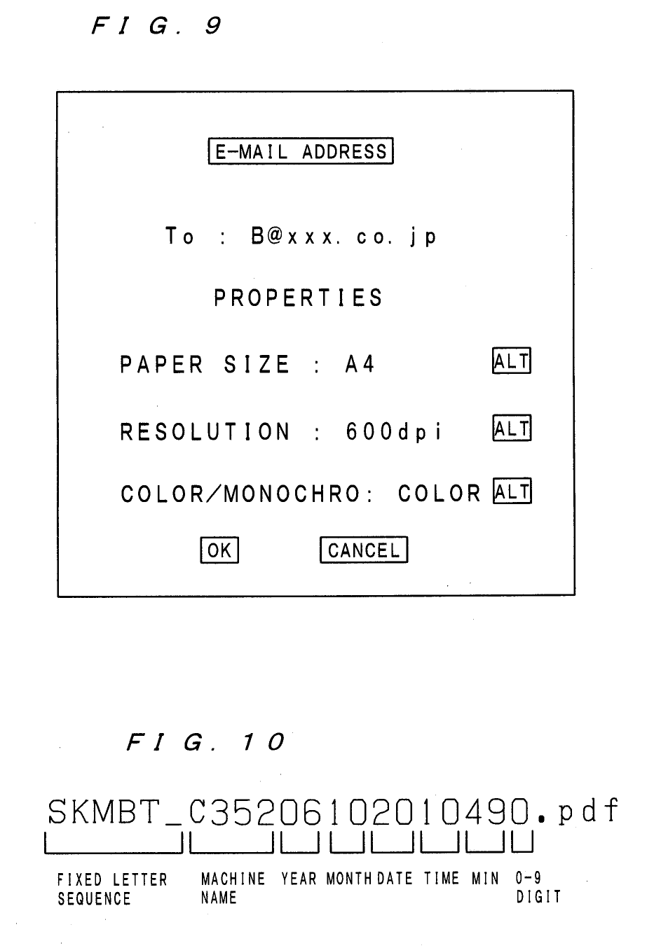

When the user A has selected one from the transmission ways, an input screen is displayed on the operation panel 104. FIG. 9 shows an exemplary input screen which is displayed when the user A selects transmission by e-mail. On this input screen, the user A inputs an e-mail address as a destination of the transmission. Further, on the input screen, with the keyboard 105, the user A inputs information on image data to be sent (which will be referred to as properties). The properties include a paper size on which the image data are to be printed, a color, resolution of the image data, etc.

The CPU 101 detects whether a destination, such as an e-mail address, a number or the like, which depends on the transmission way selected at step S100, has been input and whether the properties have been input (step S101). When the input of destination and the input of properties have been completed, that is, when an “OK” button shown in FIG. 9 is pushed, the processing goes to step S102. The processing stands by at step S101 until the “OK” button is pushed.

For every selected transmission way, input of a destination and input of properties are carried out on an input screen similar to that shown by FIG. 9. For transmission by e-mail, an e-mail address is input as the destination, and for transmission by facsimile, a facsimile number is input as the destination. For transmission to a printer, for example, an IP address is input as the destination, and for file transfer, an address of an FTP server is input as the destination. When file transfer is selected, further, it is necessary to notify the user of the FTP server of the execution of the file transfer and the destination of the file transfer. Therefore, an address for a notice e-mail is input.

After the input of destination and the input of properties, the CPU 101 detects whether the user A has made a send command (step S102). The send command is specifically pushing a “SEND” button in the transmission selection screen shown by FIG. 8. When the send command has been made, the processing goes to step S103. The processing stands by at step S102 until the send command is made.

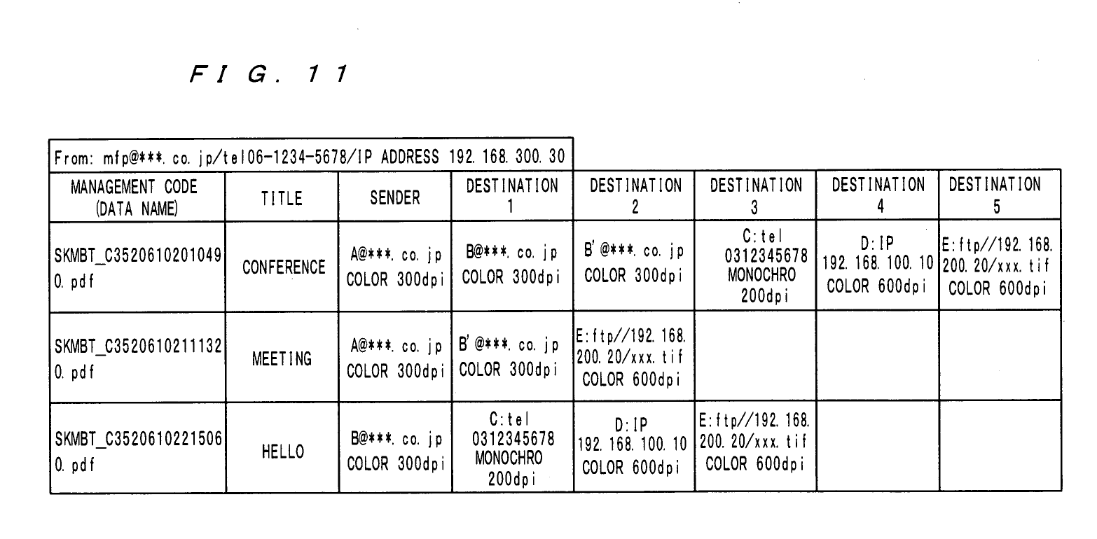

Next, the CPU 101 commands the reading section 106 to read a document image so as to obtain image data (step S103). Then, the CPU 101 provides a name for the image data (step S104). The data name is used as a management code which identifies the multicast transmission to be currently performed. The name is peculiar to the multicast transmission and is never identical to other names for other multicast transmissions. FIG. 10 shows an exemplary data name, and in this example, the data name is a combination of a fixed character sequence, a machine code, a date and time (year, month, date, hour, minute) and a digit from 0 to 9. The digit from 0 to 9 is used to distinguish the reading process from other reading processes which are executed in the same minute, and therefore, an increment is made to the digit every time a reading process is executed in the same minute.

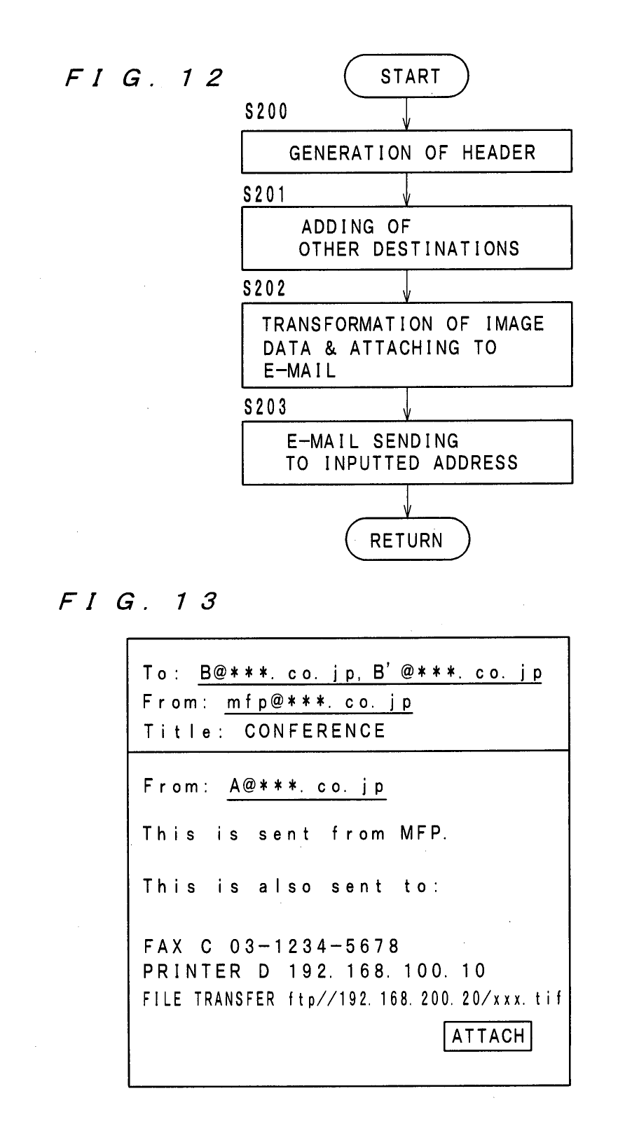

Next, the CPU 101 records such data names in a data table, and for each of the data names, the destinations and the properties of the data are also recorded in the data table (step S105). FIG. 11 is an exemplary data table. The data table as shown by FIG. 11 is stored in the storage section 103, and for every piece of image data sent by a multicast transmission, the data name, the title, the address of the image forming apparatus 100, the destinations and the properties of the image data are recorded in the data table. The data name is used as a management code for managing the multicast transmission. The destinations of the multicast transmission are an e-mail address, a facsimile number, an IP address, an address of the FTP server, etc. The properties of the image data are information on the image data, such as a paper size, etc. The data table is not necessarily stored in the storage section 103 and may be stored in a device located externally from the image forming apparatus 100, such as a server.

Next, the CPU 101 detects whether transmission by e-mail has been selected (step S106). When transmission by e-mail has been selected, the processing goes to step S107. When transmission by e-mail has not been selected, the processing goes to step S108.

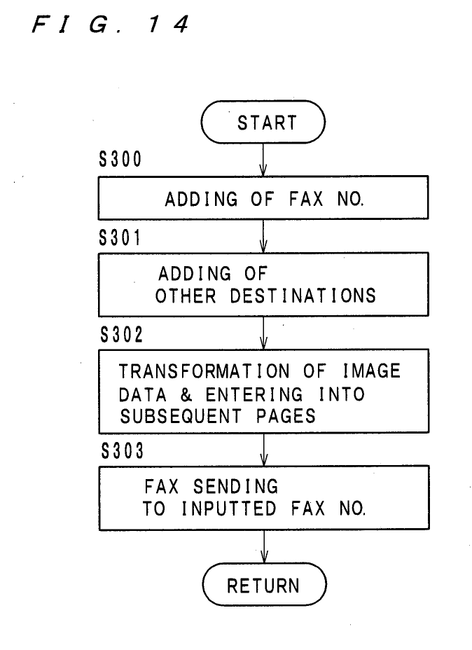

When transmission by e-mail has been selected, the CPU 101 makes an e-mail and transforms the image data obtained at step S103 into an image file format so that the image data can be attached to the e-mail. Then, the CPU 101 sends the e-mail with the image file attached thereto via the network interface 108 (step S107). In the following, referring to FIG. 12, the process executed at step S107 is described in detail. FIG. 12 is a flowchart showing a process executed by the image forming apparatus 100 to send an e-mail with an image file attached thereto.

First, the CPU 101 makes a header for the e-mail (step S200). Here, the header is made in the same process as the process of making a header for an ordinary e-mail, and a detailed description is omitted.

Next, the CPU 101 adds the destinations of the data via transmission ways other than transmission by e-mail to the text of the e-mail (step S201). Thereby, the receiver of the e-mail will be informed of the other destinations of the data.

Next, the CPU 101 transforms the image data into a specified image file and attaches the image file to the e-mail (step S202). In this process, the image data obtained by document reading, which are, for example, of a bit map format are transformed into an image file format, such as JPEG or PDF (portable document format). Then, the image file is transformed into an ASCII code by a mail extension function such as MINE (multipurpose internet mail extension) or the like.

Next, the CPU 101 sends the e-mail via the network interface 108 in accordance with the designated e-mail address (step S203).

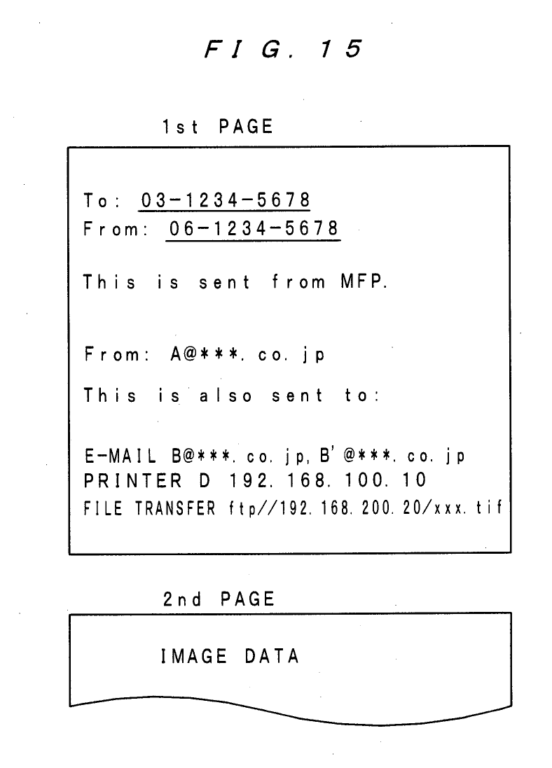

Now, the e-mail sent at step S203 is described. FIG. 13 shows an exemplary e-mail sent to the users B and B′ by a multicast transmission identified by a management code “SKMBT_C35206102010490.pdf” recorded in the data table shown by FIG. 11.

As shown in FIG. 13, the other destinations of the data, namely, the facsimile number of the facsimile 600 used by the user C and the IP address of the printer 300 used by the user D are automatically added to the text of the e-mail. Also, the address of the FTP server 500 is added.

Moreover, the e-mail includes an attachment button, and when the attachment button is pushed, the image data attached thereto are played. That is all about the process at step S107. Thereafter, the processing goes to step S108 shown in FIG. 7.

The CPU 101 detects whether transmission by facsimile has been selected (step S108). When transmission by facsimile has been selected, the processing goes to step S109. When transmission by facsimile has not been selected, the processing goes to step S110.

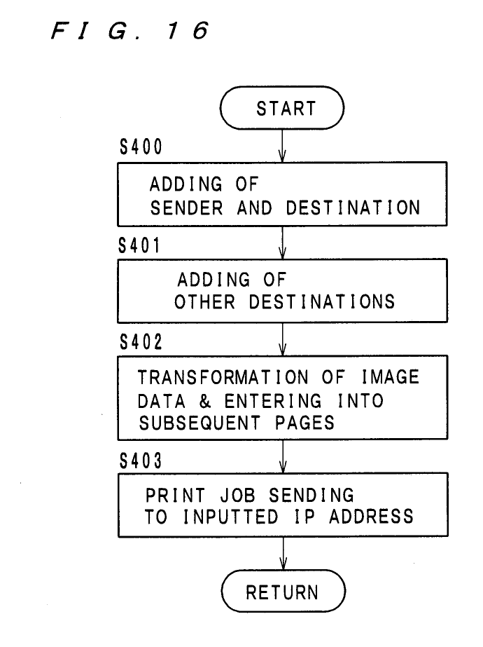

When transmission by facsimile has been selected, the CPU 101 transforms the image data into a format suited for facsimile data so that the image data can be transmitted by facsimile, and the CPU 101 sends the data in the format via the facsimile interface 109 (step S109). In the following, referring to FIG. 14, the process executed at step S109 is described in detail. FIG. 14 is a flowchart showing a process executed by the image forming apparatus 100 to transform the image data into facsimile data and to send the facsimile data.

The CPU 101 adds the sender of the facsimile data, that is, the facsimile number of the image forming apparatus 100 and the facsimile number of the receiver to the facsimile data as the first page (step S300). This process of adding the facsimile number of the sender and the facsimile number of the receiver is the same way as a process of adding facsimile numbers of the sender and the receiver for ordinary facsimile sending, and a detailed description is omitted.

Further, the CPU 101 adds the destinations of the data via transmission ways other than transmission by facsimile to the first page of the facsimile data (step S301). Thereby, the receiver of the facsimile will be informed of the other destinations of the data.

Next, the CPU 101 transforms the image data into facsimile data, and the facsimile data transformed from the image data are put in the second and succeeding pages (step S302). For example, the image data obtained by image reading are transformed into facsimile data of G3 (Group 3) standard transmittable via an analogue line or into facsimile data of high-quality G4 (Group 4) standard transmittable via an ISDN line.

Next, the CPU 101 sends the facsimile data via the facsimile interface 109 in accordance with the designated facsimile number (step S303).

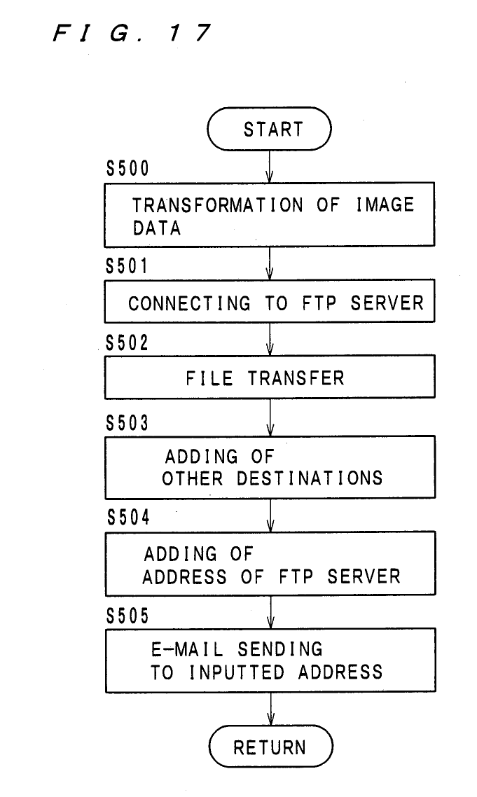

Now, the facsimile data sent at step S303 is described. FIG. 15 shows exemplary facsimile data sent by a multicast transmission identified by a management code “SKMBT_C35206102010490.pdf” recorded in the data table shown by FIG. 11.

As shown by FIG. 15, as the destinations of the data via the transmission ways other than transmission by facsimile, the e-mail addresses of the computers 200a and 200b used by the users B and B′, the IP address of the printer 300 used by the user D are automatically added as the cover page of the facsimile data. Also, the address of the FTP server 500 is added. That is all about the process executed at step S109. Thereafter, the processing goes to step S110 shown in FIG. 7.

The CPU 101 detects whether transmission to a printer has been selected (step S110). When transmission to a printer has been selected, the processing goes to step S111. When transmission to a printer has not been selected, the processing goes to step S112.

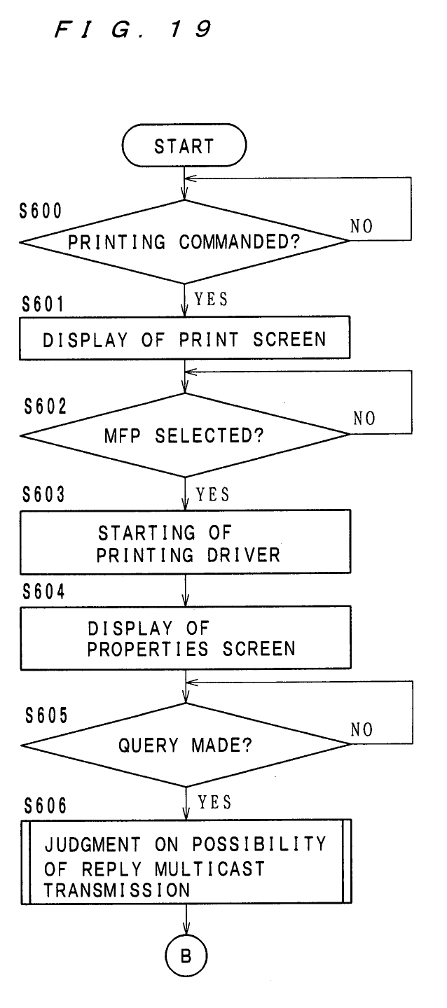

When transmission to a printer has been selected, the CPU 101 transformed the image data obtained at step S103 into a format suited for print data and sends the data in the format. In the following, referring to FIG. 16, a process executed at step S111 is described in detail. FIG. 16 is a flowchart showing the process executed by the image forming apparatus 100 to transform the image data into print data and to send the print data.

The CPU 101 adds the sender of the print data, that is, the IP address of the image forming apparatus 100 and the receiver of the print data, that is, the IP address of the printer to the print data (step S400). If the IP addresses are related to the names of the devices in the network, the names of the devices may be added instead of the IP addresses.

Next, the CPU 101 adds the destinations of the data via transmission ways other than transmission to a printer to the print data as the first page (step S401). Thereby, the receiver of the print data will be informed of the other destinations of the image data.

Next, the CPU 101 transforms the image data into print data (step S402). For example, the image data are transformed into PDL (page-description language), and the data are to be printed on the second and succeeding pages. The PDL is, for example, Postscript (trade name).

Next, the CPU 101 sends the print data to the printer with the designated IP address (step S403). That is all about the process executed at step S111. Thereafter, the processing goes to step S112.

At step S112, the CPU 101 detects whether file transfer via the FTP server has been selected. When file transfer has been selected, the processing goes to step S113. When file transfer has not been selected, the processing is completed.

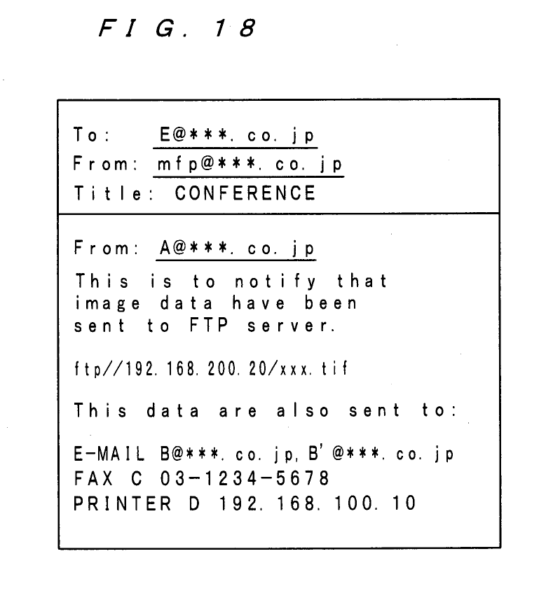

When file transfer has been selected, the CPU 101 transforms the image data obtained at step S103 into a format which permits file transfer of the image data via the FTP server and sends the data in the format to the FTP server (step S113). Then, the CPU 101 sends a notice e-mail to notify the user of the FTP server of the file transfer. FIG. 17 is a flowchart executed by the image forming apparatus 100 to transform the image data into the format suited for file transfer, to send the image data in the format to the FTP server and to send the notice e-mail.

The CPU 101 transforms the image data into an image file format to be received by the FTP server, such as GIF (graphics interchange format), TIFF (tagged image file format) or the like (step S500).

Next, the CPU 101 makes a connection for communication with the FTP server 500 (step S501). Then, the CPU 101 transmits the image file to the FTP server 500 (step S502).

Next, the CPU 101 adds the destinations of the image data via transmission ways other than file transfer via the FTP server to the text of the notice e-mail (step S503).

Next, the CPU 101 adds the address of the FTP server to which the image file was sent to the text of the notice e-mail (step S504). Thereby, the user of the FTP server is informed that the image file was sent to the FTP server.

Finally, the CPU 101 sends the notice e-mail via the network interface 108 in accordance with the designated address (step S505).

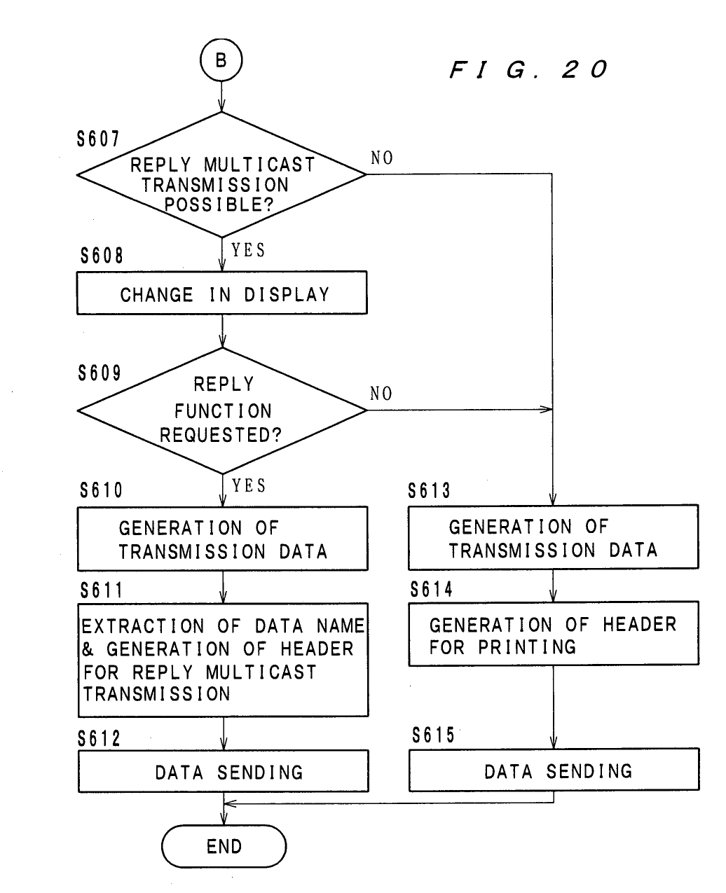

Now, the notice e-mail sent at step S505 is described. FIG. 18 shows an exemplary notice e-mail sent to the user E by the multicast transmission identified by a management code “SKMBT_C35206102010496.pdf” recorded in the data table shown by FIG. 11. To the text of the e-mail, the destinations of the image data via transmission ways other than file transfer via the FTP server 500 are automatically added. That is all about the process executed at step S113. Then, the processing is completed.

Thus, according to the present embodiment, the image forming apparatus 100 transforms image data obtained by image reading into various formats, such as a format suited for an attachment to an e-mail, a format suited for transmission by facsimile, etc., and sends the image data in various formats. At the same time, the destinations of the image data sent by the multicast transmission and the image data name for identifying the multicast transmission are recorded as history information in a data table as shown by FIG. 11. The history information is used for a reply multicast transmission, which will be described below.

### [Reply Multicast Transmission]

Next, a reply multicast transmission in the data communication system according to the present embodiment is described. First, the user B of the computer 200a, with a software for processing an image or a document (for example, Acrobat (trade name) of Adobe Systems Incorporated) installed in the computer 200a, makes alterations (for example, corrections or revisions) to original image data previously sent thereto by a multicast transmission. Then, the user B performs a reply multicast transmission of the altered image data by use of a printing driver for making a print command to the image forming apparatus 100. In response to the print command, the image forming apparatus 100 sends the altered image data by a reply multicast transmission to the destinations of the previous multicast transmission by which the original image data was transmitted. The process of a reply multicast transmission is described with reference to the accompanying drawings.

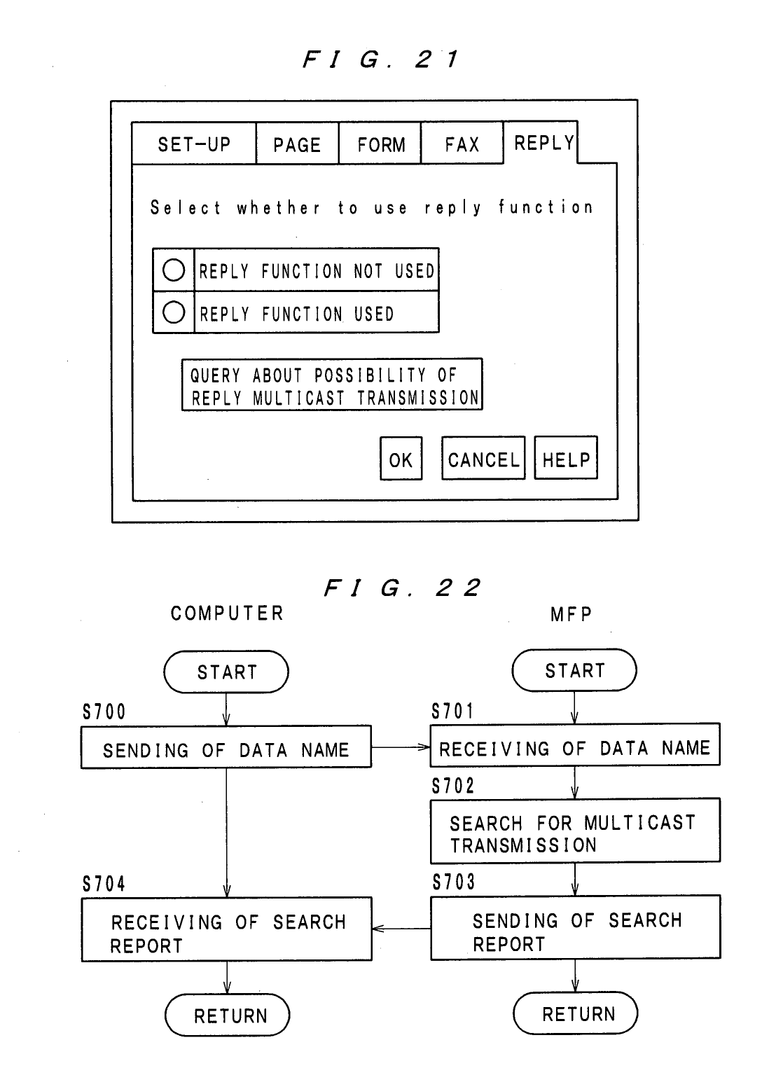

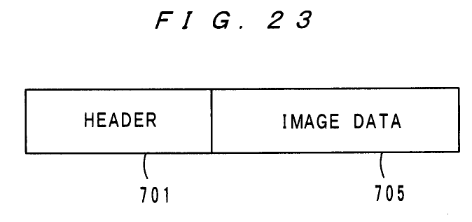

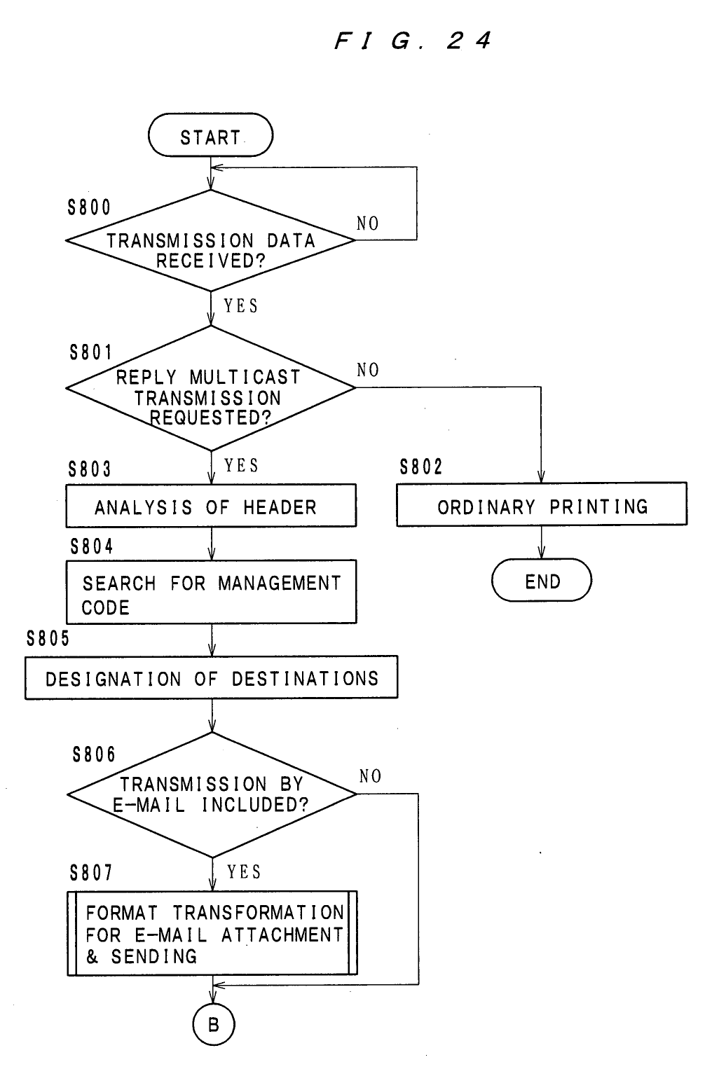

FIGS. 19 and 20 are flowcharts showing a procedure carried out by the computer 200a to execute a reply multicast transmission in the data communication system according to the present embodiment. FIG. 21 is a properties screen for a printing driver installed in the computer 200a. FIG. 22 is a flowchart showing a process carried out by the CPU 201 of the computer 200a and the CPU 101 of the image forming apparatus 100 at step S606 in the flowchart of FIG. 19.

First, with a software, for example, Acrobat (trade name) of Adobe Systems Incorporation, the user B commands the computer 200a to play original data previously sent to the computer 200a by a multicast transmission without changing the data name and makes alterations (corrections or revisions) to the image data.

After the alteration to the data, the CPU 202 stands by while detecting whether a print command has been made (step S600). The user B, while operating the software, clicks a print button on a window of the software to make a print command. In response to the print command, the CPU 201 displays a print screen on the display 204 (step S601).

Next, the CPU 201 stands by while detecting whether the user B has selected the image forming apparatus 100 as a printer used (step S602). When the user B has selected the image forming apparatus 100, the CPU 201 starts a printing driver for the image forming apparatus 100 (step S603). Further, the CPU 201 displays a properties screen for the printing driver (step S604). At this stage, check boxes for “Reply function Used” and for “Reply Function Not Used” are shadowed so that the user cannot select either of the check boxes.

While the properties screen is displayed, the CPU 201 stands by while detecting whether the user B has made a query to the image forming apparatus 100 about possibility of a reply multicast transmission (step S605). When the user B has clicked a button “Query about Possibility of Reply Multicast Transmission” shown in FIG. 21, the processing goes to step S606.

At step S606, it is judged by the computer 200a and the image forming apparatus 100 whether the reply multicast transmission is possible. More specifically, the CPU 201 sends the data name of the altered image data to the image forming apparatus 100 via the network interface 206 (step S700). The data name of the altered image data is identical to that of the original image data and is, for example, “SKMBT_C35206102010490.pdf” as shown in FIG. 10. The image forming apparatus 100 receives the data name (at step S701).

The CPU 101 searches for a previous multicast transmission with the management code corresponding to the data name (step S702). More specifically, the image forming apparatus 100 stores the data table shown by FIG. 11, and the CPU 101 searches the data table for a management code corresponding to the data name.

Next, the CPU 101 sends a search report to the computer 200a via the network interface 108 (step S703). More specifically, when there is a management code corresponding to the data name in the data table, the CPU 101 informs the computer 200a via the network interface 108 that the reply multicast transmission is possible. On the other hand, when there is no management code corresponding to the image data name in the data table, the CPU 101 informs the computer 200a via the network interface 108 that the reply multicast transmission is impossible.

The CPU 201 receives the search report via the network interface 206 (step S704). That is all about the process at step S606. Thereafter, the processing goes to step S607.

From the search report sent from the image forming apparatus 100, the CPU 201 judges whether the reply multicast transmission is possible (step S607). When the reply multicast transmission is possible, the processing goes to step S608. When the reply multicast transmission is impossible, the processing goes to step S613, and ordinary printing is started.

When the reply multicast transmission is possible, the CPU 201 changes the display of the check boxes “Reply Function Used” and “Reply Function Not Used” on the properties screen for the printing driver so that the user B can select either of the check boxes (step S608). Then, the user B, on the properties screen, selects either of the check boxes “Reply Function Used” and “Reply Function Not Used”.

The CPU 201 judges whether execution of the reply multicast transmission is necessary by detecting which check box the user B has checked, “Reply Function Used” or “Reply Function Not Used” (step S609). When execution of the reply multicast transmission is necessary, the processing goes to step S610. On the other hand, when execution of the reply multicast transmission is not necessary, the processing goes to step S613, and ordinary printing is started.

When execution of the reply multicast transmission is necessary, the CPU 201 transforms the altered image data into PDL (step S610) and makes a header in PDL for the reply multicast transmission (step S611).

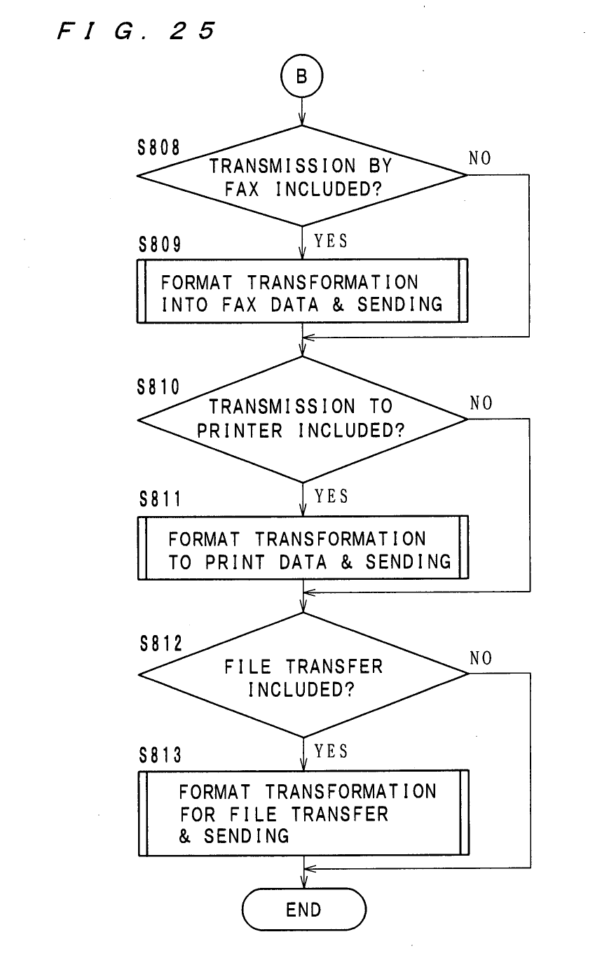

Now, data transmitted from the computer 200a to the image forming apparatus 100 for a reply multicast transmission or for ordinary printing (which will be referred to as transmission data) are described with reference to the accompanying drawings. FIG. 23 shows the structure of the transmission data.

As FIG. 23 shows, the transmission data comprises a header block 701 and an image data block 705, and these blocks 701 and 705 are in a form of print data which can be printed out by the image forming apparatus 100. Accordingly, as mentioned, the transmission data is in the form of PDL. The header block 701 includes at least the data name (corresponding to the management code) for identifying a previous multicast transmission and information on the necessity of execution of a reply multicast transmission. The data name is the data name of the altered image data. The user B made alterations to original image data without changing the data name, and the data name of the altered image data is identical to the data name of the original image data. The image data block 705 includes the altered image data. At step S611, the CPU 201 extracts the data name of the altered image data and enters the data name into the header block 701, and the CPU 201 also enters an instruction to the image forming apparatus 100 not to print the altered image data into the header block 701. In this way, the header block 701 is made.

On completion of preparation of the transmission data, the CPU 201 sends the transmission data to the image forming apparatus 100 via the network interface 206 (step S612). Then, in the image forming apparatus 100, a process of executing a reply multicast transmission starts.

On the other hand, at step S613, the CPU 201 transforms the altered image data into PDL (step S613). Further, the CPU 201 makes a header block 701 for ordinary printing (step S614). The header block 701 for ordinary printing includes instructions to the image forming apparatus 100 not to execute a reply multicast transmission and to print the altered image data. Thus, transmission data for ordinary printing is completed.

On completion of preparation of transmission data for ordinary printing, the CPU 201 sends the transmission data to the image forming apparatus 100 via the network interface 206 (step S615). Then, in the image forming apparatus 100, a process of ordinary printing starts.

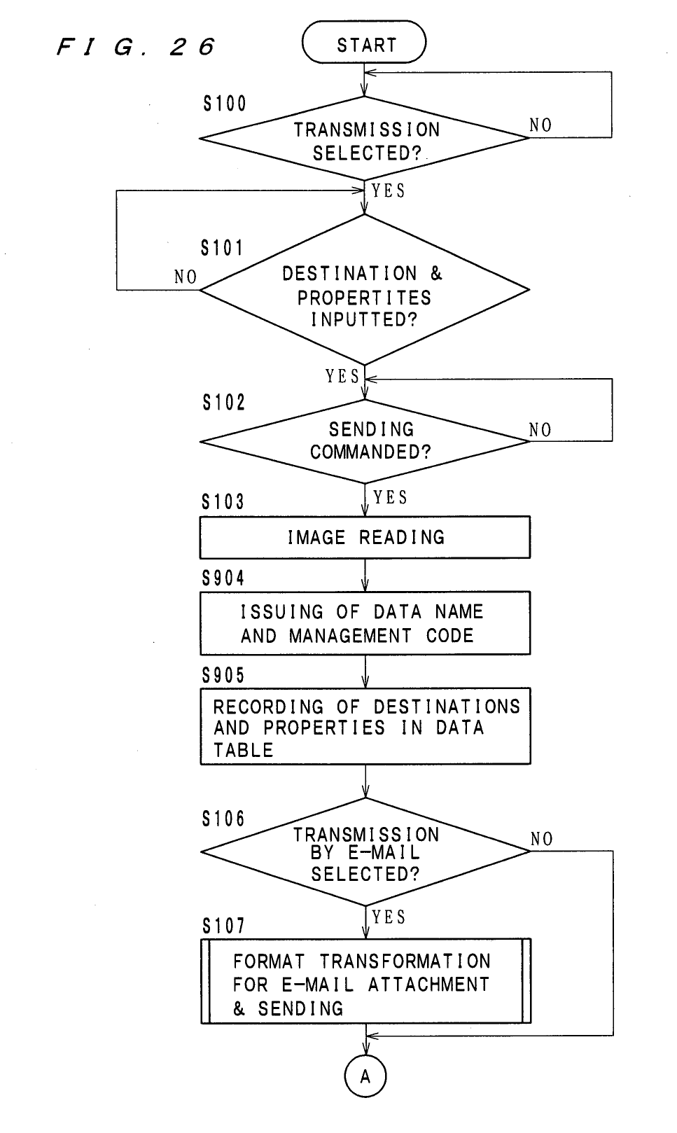

Next, the operation of the image forming apparatus 100 after reception of the transmission data is described with reference to the accompanying drawings. FIGS. 24 and 25 are flowcharts showing a procedure carried out by the image forming apparatus 100 after the image forming apparatus 100 has received the transmission data.

The CPU 101 stands by at step S800 while detecting whether the transmission data has been sent from the computer 200a. When the CPU 101 detects reception of the transmission data, the processing goes to step S801.

The CPU 101 extracts information on the necessity of a reply multicast transmission from the header block 701 and judges whether to execute a reply multicast transmission (step S801). When execution of a reply multicast transmission is not necessary, the processing goes to step S802. When execution of a reply multicast transmission is necessary, the processing goes to step S803.

When execution of a reply multicast transmission is not necessary, the CPU 101 executes ordinary printing (step S802). More specifically, the CPU 101 commands the printing section 110 of the image forming apparatus 100 to print the altered image data on a paper. Thus, the processing is completed.

When execution of a reply multicast transmission is necessary, the CPU 101 extracts the data name (management code) from the header block 701 (at step S803). Next, the CPU 101 searches the data table in the storage section 103 for the management code (step S804). More specifically, the CPU 101 examines whether there is, in the data table, a management code corresponding to the data name extracted from the header block 701. Next, with reference to the destinations of a previous multicast transmission identified by the management code, the CPU 101 designates destinations of the reply multicast transmission (step S805). For example, when the reply multicast transmission is in reply to the multicast transmission provided with the management code “SKMBT_C35206102010490.pdf” shown in FIG. 11, destinations of the reply multicast transmission are the e-mail address of the computer 200b used by the user B′, the facsimile number of the facsimile 600 used by the user C, the IP address of the printer 300 used by the user D and the address of the FTP server 500.

Next, the CPU 101 detects whether the reply multicast transmission includes transmission by e-mail (step S806). When transmission by e-mail is included, the processing-goes to step S807. When transmission by e-mail is not included, the processing goes to step S808.

When transmission by e-mail is included, the CPU 101 makes an e-mail and transforms the altered image data into an image file format so that the altered image data can be attached to the e-mail. Then, the CPU 101 sends the e-mail with the image file attached thereto via the network interface 108 (step S807). The process carried out by the CPU 101 at step S807 is the same as the process carried out at step S107 shown in FIG. 6, and a detailed description of the process is omitted. Thereafter, the processing goes to step S808.

At step S808, the CPU 101 detects whether the reply multicast transmission includes transmission by facsimile. When transmission by facsimile is included, the processing goes to step S809. When transmission by facsimile is not included, the processing goes to step S810.

When transmission by facsimile is included, the CPU 101 transforms the altered image data into a format suited for facsimile data and sends the transformed data via the facsimile interface 109 (step S809). The process carried out by the CPU 101 at step S809 is the same as the process carried out at step S109 shown in FIG. 6, and a detailed description of the process is omitted. Thereafter, the processing goes to step S810.

At step S810, the CPU 101 detects whether the reply multicast transmission includes transmission to a printer. When transmission to a printer is included, the processing goes to step S811. When transmission to a printer is not included, the processing goes to step S812.

When transmission to a printer is included, the CPU 101 transforms the altered image data into a format suited for print data and sends the altered image data as print data (step S811). The process carried out by the CPU 101 at step S811 is the same as the process carried out at step S111 shown in FIG. 6, and a detailed description of the process is omitted. Thereafter, the processing goes to step S812.

At step S812, the CPU 101 detects whether the reply multicast transmission includes file transfer via an FTP server (step S812). When file transfer via an FTP server is included, the processing goes to step S813. When file transfer via an FTP server is not included, the processing goes to step S812.

When file transfer via an FTP server is included, the CPU 101 transforms the altered image data into a format which can be transmitted to an FTP server, and the CPU 101 sends the file to the FTP server (step S813). The CPU 101 also sends a notice e-mail. The process carried out by the CPU 101 at step S813 is the same as the process carried out at step S113 shown in FIG. 6, and a detailed description of the procedure is omitted. Thereafter, the processing goes to step S813.

Thus, in the data communication system according to the present embodiment, the computer 200a carries out a reply multicast transmission in cooperation with the image forming apparatus 100 by using the printing driver for the image forming apparatus 100. Therefore, when the user B of the computer 200a is to make alterations with a software to original image data sent by a multicast transmission and then is to send the altered image data by a reply multicast transmission, the user B does not have to store the altered image data into the storage section 203 such as a hard disk. In the following, this is described in detail.

Conventionally, a user makes alterations to original image data with a software and stores the altered image data into a storage section, and then, the user executes a reply multicast transmission. In the data transmission system described above, however, the user makes alterations to original data with a software without changing the data name, and while operating the software, the user starts a printing driver and commands a reply multicast transmission by sending the data name and the altered image data with the printing driver. Ordinary printing of the altered image data can be executed without storing the altered image data into a storage section, and likewise, a reply multicast transmission of the altered image data can be executed without storing the altered image data into a storage section.

### Second Embodiment

Second exemplary operation of the data communication system is hereinafter described. In the first embodiment, the computer 200a sends the name of original image data to the image forming apparatus 100, and the image forming apparatus 100 searches for a multicast transmission by which the original image data was sent to the computer 200a. In the second embodiment, however, as the object of a reply multicast transmission, the user B of the computer 200a can select a desired one from a plural number of multicast transmissions previously executed from the user A of the image forming apparatus 100 to the user B of the computer 200a. Therefore, in the second embodiment, the computer 200a sends the user's name (user B) of the computer 200a to the image forming apparatus 100, and the image forming apparatus 100 searches for multicast transmissions previously executed from the user A to the user B. In the following, mainly the differences between the first embodiment and the second embodiment are described.

### [Multicast Transmission]

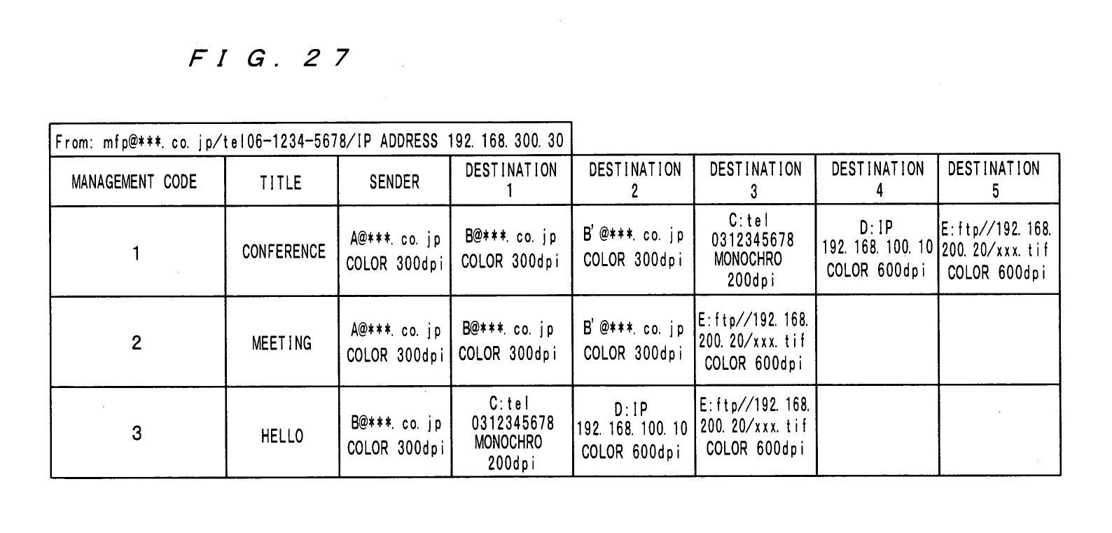

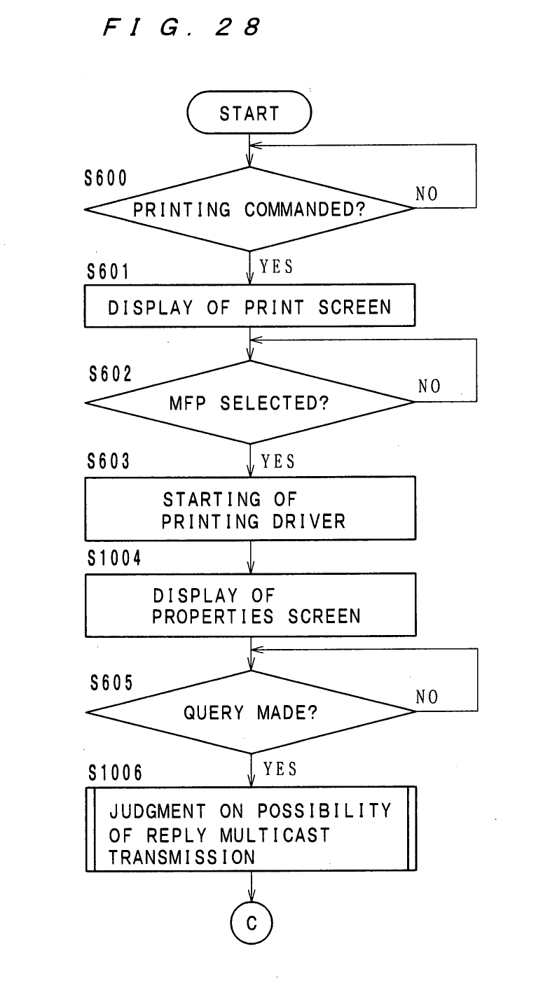

FIG. 26 is a flowchart showing a procedure carried out by the image forming apparatus 100 for a multicast transmission according to the second embodiment. The flowchart of FIG. 26 is followed by the flowchart of FIG. 7. FIG. 27 shows a data table used for the second embodiment.

In the second embodiment, processes at steps S100 to S103 are the same as those at steps S100 to S103 shown in FIG. 6 in the first embodiment, and detailed descriptions of these steps are omitted.

The CPU 101 provides a data name for image data, and provides a management code for a multicast transmission to be currently executed (step S904). The data name provided here is the same as that in the first embodiment, and a detailed description is omitted. The management code is to identify the multicast transmission, and the management code is peculiar to the multicast transmission and is never identical to other codes for other multicast transmissions. For example, the management code may include digits showing the date and time. Here, for simplification of description, numbers 1, 2, . . . are used as the management codes.

Next, the CPU 101 records destinations and properties for the multicast transmission in a data table shown by FIG. 27 (step S905). Like the data table shown by FIG. 11, the data table shown by FIG. 27 is stored in the storage section 103. In the data table shown by FIG. 11, the data names are used as management codes. In the data table shown by FIG. 27, on the other hand, names different from data names and peculiar to the respective multicast transmissions are used as management codes.

The processes at steps S106 to S113 in the second embodiment are the same as the processes at steps S106 to S113 shown by FIGS. 6 and 7 in the first embodiment, and detailed descriptions of these steps are omitted.

### [Reply Multicast Transmission]

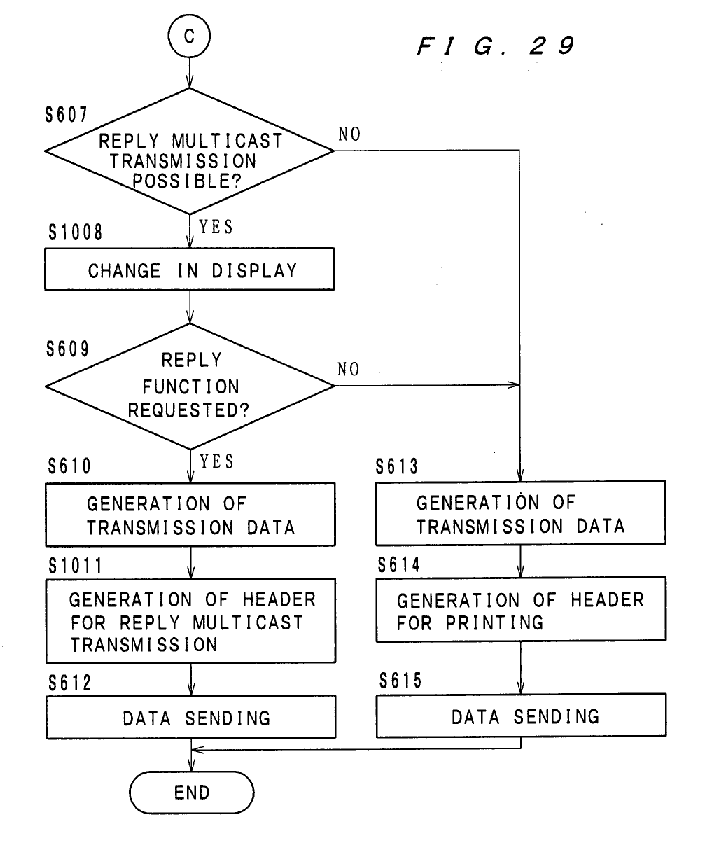

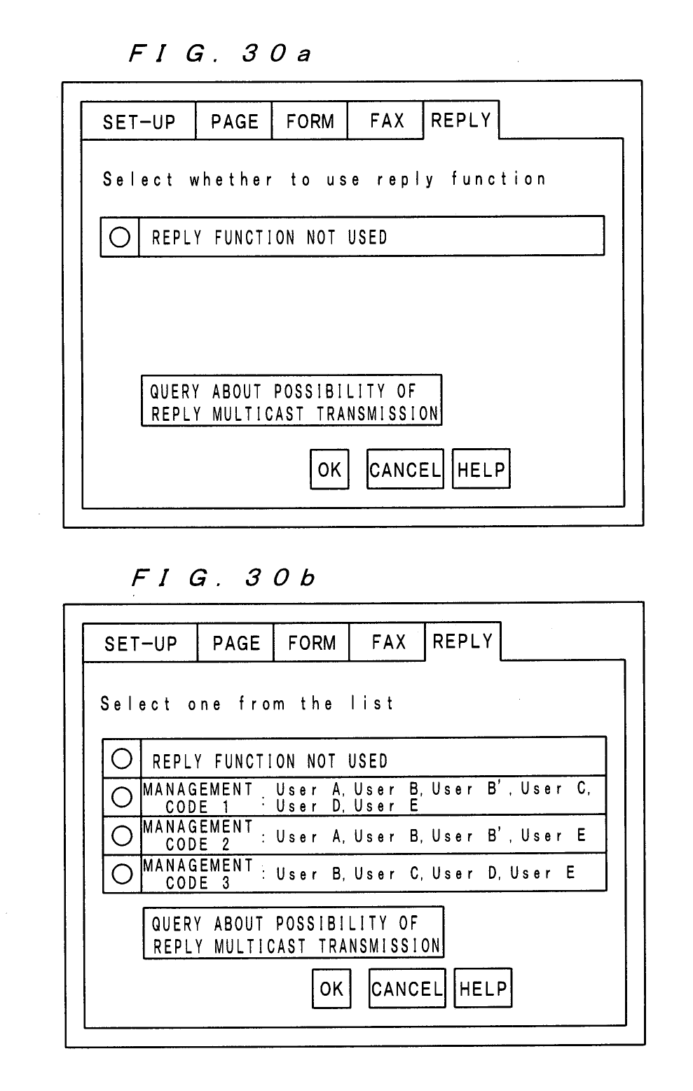

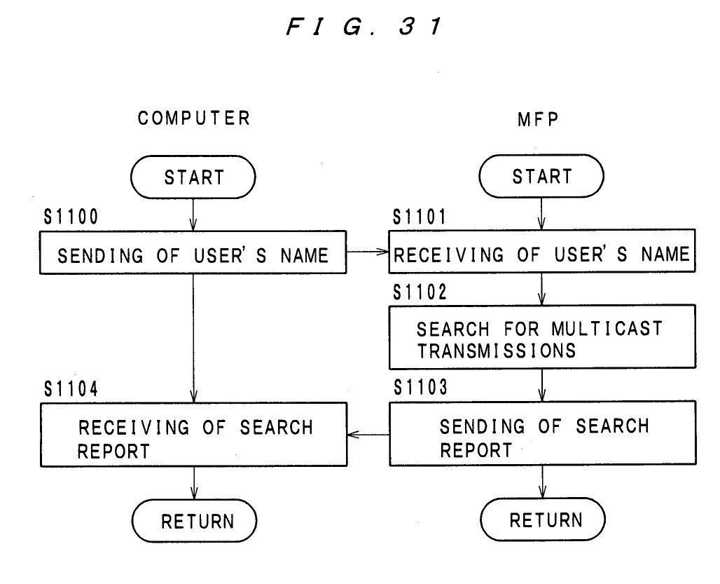

FIGS. 28 and 29 are flowcharts showing a procedure carried out by the computer 200a for a reply multicast transmission. FIG. 30 shows an exemplary properties screen for a reply multicast transmission to be displayed on the display 204 of the computer 200a. FIG. 31 is a flowchart showing a procedure carried out by the image forming apparatus 100 and the computer 200a for a reply multicast transmission.

The processes at steps S600 to S603 in the second embodiment are the same as those at steps 600 to S603 shown in FIG. 19 in the first embodiment, and detailed descriptions of these steps are omitted. When a printing driver is started, the CPU 201 displays the properties screen shown by FIG. 30a on the display 204 (step S1004). Thereafter, the process at step S605 is carried out.

While the properties screen is displayed, the CPU 201 stands by while detecting whether the user B has made a query to the image forming apparatus 100 about possibility of the reply multicast transmission (step S605). When the user B has clicked a button “Query about Possibility of Reply Multicast Transmission” shown in FIG. 30a, the processing goes to step S1006.

At step S1006, it is judged by the computer 200a and the image forming apparatus 100 whether the reply multicast transmission is possible. More specifically, as FIG. 31 shows, the CPU 201 sends the user's name (user B) of the computer 200a to the image forming apparatus 100 via the network interface 206 (step S1100). The user's name may be the name itself of the user B or may be the address (for example, the e-mail address) of the user B. The image forming apparatus 100 receives the user's name (at step S1101).

The CPU 101 searches for multicast transmissions previously executed to the destination corresponding to the user's name (step S1102). More specifically, the image forming apparatus 100 stores the data table shown by FIG. 27, and the CPU 101 searches the data table for multicast transmissions previously executed to destinations including the destination corresponding to the user's name and lists the management codes of the multicast transmissions.

Next, the CPU 101 sends a search report to the computer 200a via the network interface 108 (step S1103). More specifically, the CPU 101 sends a list of management codes and destinations of the respective multicast transmissions identified by the management codes to the computer 200a. On the other hand, when there is no destination corresponding to the user's name in the data table, the CPU 101 informs the computer 200a that the reply multicast transmission is impossible.

The CPU 201 receives the search report via the network interface 206 (step S704). That is all about the process at step S1006. Thereafter, the processing goes to step S607.

At step S607, the CPU 201 judges from the search report whether the reply multicast transmission is possible. More specifically, when the CPU 201 receives the list of management codes and destinations of multicast transmissions identified by the management codes from the image forming apparatus 100, the CPU 201 judges that the reply multicast transmission is possible. On the other hand, when the CPU 201 receives a notice of impossibility of the reply multicast transmission from the image forming apparatus 100, the CPU 201 judges that the reply multicast transmission is impossible. When the reply multicast transmission is possible, the processing goes to step S1008. When the reply multicast transmission is impossible, the processing goes to step S613 to start ordinary printing.

When the reply multicast transmission is possible, the CPU 201 displays a properties screen as shown by 30b (step S1008). More specifically, the CPU 201 makes the properties screen as shown by FIG. 30b based on the management codes and the destinations of multicast transmissions listed in the search report sent from the image forming apparatus 100. Therefore, on the properties screen, the management codes and the destinations of multicast transmissions previously sent to the user B are listed. The user B can designate a multicast transmission as the object of the reply multicast transmission by selecting one from the multicast transmissions listed on the properties screen.

The CPU 201 judges whether execution of the reply multicast transmission is necessary by detecting whether the user has checked a check box “Reply Function Not Used” (step S609). When execution of the reply multicast transmission is necessary, the processing goes to step S610. On the other hand, when execution of the reply multicast transmission is not necessary, the processing goes to step S613 to start ordinary printing. Ordinary printing in the second embodiment is carried out in the same way as in the first embodiment, and a detailed description is omitted.

When execution of the reply multicast transmission is necessary, the CPU 201 makes an image data block 705 by transforming the altered image data into PDL (S610). Concurrently, the CPU 201 makes a header block 701 in PDL (step S1011). The header block 701 in the second embodiment includes at least the management code for identifying the previous multicast transmission which is the object of the reply multicast transmission or information that execution of the reply multicast transmission is unnecessary.

On completion of preparation of transmission data, the CPU 201 sends the transmission data to the image forming apparatus 100 via the network interface 206 (step S612).

In the second embodiment, after receiving the transmission data, the image forming apparatus 100 carries out basically the same processes as in the first embodiment. It is to be noted that because in the second embodiment, the header block 701 includes a management code, not a data name, at step S804 shown in FIG. 24, the image forming apparatus 100 searches the data table for the management code included in the header 701.

In the data communication system according to the second embodiment, as in the system according to the first embodiment, a reply multicast transmission from the computer 200a can be executed with the printing driver for the image forming apparatus 100. Therefore, when the user B is to make alterations to original image data sent to the computer 200a by a multicast transmission with a software, the user B of the computer 200a does not have to store the original image data in the storage section 203 such as a hard disk.

In the data communication system according to the second embodiment, when the computer 200a makes a query to the image forming apparatus 100 about possibility of a reply multicast transmission, the computer 200a sends the user's name (user B) thereof. The image forming apparatus 100 lists previous multicast transmissions executed to destinations including the destination corresponding to the user's name and sends information on the multicast transmissions to the computer 200a. Thereby, as the object of the reply multicast transmission, the user can select one from the multicast transmissions previously sent thereto.

In the data communication system according to the second embodiment, the data sent by a reply multicast transmission are not necessarily altered image data. The data sent by a reply multicast transmission may be data not relating to original data sent by a previous multicast transmission.

In the first embodiment and in the second embodiment, the image forming apparatus 100 is not necessarily an MFP as long as the image forming apparatus 100 functions as a multicast transmitter and as a printer.

In the first embodiment and in the second embodiment, the data sent by a multicast transmission or a reply multicast transmission are not necessarily image data, and the data may be, for example, text data or the like.

According to the first embodiment and the second embodiment, the user of one of the destinations of a multicast transmission, by sending identification information for identifying the multicast transmission to the image forming apparatus, knows whether a reply multicast transmission to the multicast transmission is possible before starting a procedure to execute a reply multicast transmission.

According to the second embodiment, the user of one of the destinations of a multicast transmission can designate a multicast transmission as the object of a reply multicast transmission by selecting one from multicast transmissions previously executed to the user.

According to the first embodiment and the second embodiment, the image forming apparatus can execute a multicast transmission or a reply multicast transmission to data communication devices of different communication protocols.

According to the first embodiment, data sent from the image forming apparatus by a multicast transmission generally includes information which can identify the multicast transmission, such as a data name or the content of the data. Thus, when a communication device which received the multicast transmission is to send a reply multicast transmission, by using the information sent by the multicast transmission, the communication device can easily generate information for permitting the image forming apparatus to search for destinations of the reply multicast transmission.

Although the present invention has been described in connection with the preferred embodiments above, it is to be noted that various changes and modifications are possible to those who are skilled in the art. Such changes and modifications are to be understood as being within the scope of the present invention.

What is claimed is:

1. A data communication system wherein an image forming apparatus and a data communication device are connected to each other so as to be communicable with each other,
wherein said image forming apparatus comprises:
a first transmitting section for executing a multicast transmission of first data to a plural number of destinations;
a storage section for storing history information on executed multicast transmissions, said history information including destinations of the multicast transmissions; and
a printing section for printing an image in accordance with print data,
wherein said data communication device comprises:
a second receiving section for receiving the first data sent by the multicast transmission;
a data generating section for generating print data comprising identification information for identifying the multicast transmission and second data to be sent by a reply multicast transmission; and
a second transmitting section for sending the print data to the image forming apparatus,
wherein said image forming apparatus further comprises:
a first receiving section for receiving the print data;
an analyzing section for analyzing the print data and extracting the identification information from the print data; and
a designating section for designating destinations of the reply multicast transmission based on the history information and the identification information, and
wherein the first transmitting section executes the reply multicast transmission of the second data to the destinations designated by the designating section.

2. An image forming apparatus comprising:
a transmitting section for sending first data to a plural number of destinations by a multicast transmission;
a storage section for storing history information on executed multicast transmissions, said history information including destinations of the multicast transmissions;
a printing section for printing an image in accordance with print data;
a receiving section for receiving print data from one of the destinations of the multicast transmission of the first data, said print data comprising identification information for identifying the multicast transmission and second data to be sent by a reply multicast transmission;
an analyzing section for analyzing the print data and extracting the identification information from the print data; and
a first designating section for designating destinations of the reply multicast transmission based on the history information and the identification information,
wherein said transmitting section executes the reply multicast transmission of the second data to the destinations designated by the first designating section.

3. An image forming apparatus according to claim 2, further comprising a judging section whether a multicast transmission identified by the identification information sent from one of the destinations of the multicast transmission and received by said receiving section is included in the history information,
wherein said transmitting section sends a result of judgment made by the judging section to the destination from which the identification information was sent.

4. An image forming apparatus according to claim 2, further comprising a second designating section for, based on the identification information sent from one of the destinations of a multicast transmission and received by said receiving section and the history information, designating a multicast transmission executed to the destination from which the identification information was sent,
wherein said transmitting section sends information on the multicast transmission designated by the second designating section to the destination from which the identification information was sent.

5. An image forming apparatus according to claim 2, further comprising a reading section for reading an image to obtain the first data.

6. An image forming apparatus according to claim 2, further comprising a transforming section for transforming the first data into a format in accordance with a communication protocol of each destination of the multicast transmission and for transforming the second data into a format in accordance with a communication protocol of each destination of the reply multicast transmission,
wherein the transmitting section executes the multicast transmission of the transformed first data and the reply multicast transmission of the transformed second data.

7. An image forming apparatus according to claim 2, wherein the print data is in a page-description language.

8. A data communication device comprising:
a receiving section for receiving first data sent from an image forming apparatus by a multicast transmission;
a generating section for generating print data comprising identification information for identifying the multicast transmission and second data to be sent by a reply multicast transmission; and
a transmitting section for sending the print data to the image forming apparatus.

9. A data communication device according to claim 8, wherein said generating section generates the identification information based on the first data.

10. A data communication device according to claim 8, further comprising an altering section for generating the second data by making alterations to the first data.

11. A data communication device according to claim 8, wherein the print data is in a page-description language.

12. A storage medium stored with a program carried out by a data communication device which receives first data sent from an image forming apparatus by a multicast transmission, said program controlling the data communication device to carry out a procedure comprising:
a step of generating print data comprising identification information for identifying the multicast transmission and second data to be sent by a reply multicast transmission; and
a step of sending the print data to the image forming apparatus.

13. A data communication method carried out by a data communication system wherein an image forming apparatus comprising a printing section for printing an image in accordance with print data and a data communication device are connected to each other so as to be communicable with each other, said method comprising:
a step wherein the image forming apparatus executes a multicast transmission of first data to a plural number of destinations;
a step wherein the image forming apparatus stores history information on the multicast transmission, said history information including destinations of the multicast transmission;
a step wherein the data communication device receives the first data sent by the multicast transmission;
a step wherein the data communication device generates print data comprising identification information for identifying the multicast transmission and second data to be sent by a reply multicast transmission;
a step wherein the data communication device sends the print data to the image forming apparatus;
a step wherein the image forming apparatus receives the print data;
a step wherein the image forming apparatus analyzes the print data and extracts the identification information from the print data;
a step wherein the image forming apparatus designates destinations of the reply multicast transmission based on the history information and the identification information; and
a step wherein the image forming apparatus executes the reply multicast transmission of the second data to the designated destinations.
